(19) United States
(12) Patent Application Publication
(10) Pub. No.: US 2005/0127194 A1
(43) Pub. Date: Jun. 16, 2005

(54) Water-bearing household appliance, in particular, washing machine

(75) Inventors: Andreas Lahrmann, Berlin (DE); Walter Preis, Gernrode (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/994,947

(22) Filed: Nov. 22, 2004

Related U.S. Application Data
(63) Continuation of application No. PCT/EP03/05127, filed on May 15, 2003.

(30) Foreign Application Priority Data
May 21, 2002 (DE) 102 22 406.4

(51) Int. Cl. G05D 23/13; D06F 33/00; D06F 39/04; D06F 39/08

(52) U.S. Cl. 236/12.15; 68/12.22

(57) ABSTRACT

A water-guiding household appliance, in particular, a washing machine, connected to a first water supply line for cold water and to a second water supply line for hot water has the water supply lines connected to a mixer tap enabling water to flow into a suds container through a supply line. The mixer tap is integrated into a regulating device used to regulate the temperature of the water flowing into the suds container.

### CROSS-REFERENCE TO RELATED APPLICATION

This is a continuing application, under 35 U.S.C. § 120, of copending international application No. PCT/EP03/05127, filed May 15, 2003, which designated the United States; this application also claims the priority, under 35 U.S.C. § 119, of German patent application No. 102 22 406.4, filed May 21, 2002; the prior applications are herewith incorporated by reference in their entirety.

### BACKGROUND OF THE INVENTION

### FIELD OF THE INVENTION

The invention relates to a water-bearing household appliance, in particular, a washing machine, which is connected to a first water supply line for cold water and to a second water supply line for hot water, the water supply lines being connected to a mixing faucet from which a washing tub can be filled with water by a feed line.

Such a household appliance is already known from U.S. Pat. No. 4,147,297 to Worst, where a washing machine is described having two supply lines respectively connected to a cold water connection and to a hot water connection. The supply lines are connected to a mixing faucet having two electrically operated valves. Hot, warm, or cold water is let into a washing tub in the washing machine through a supply hose, depending on the opening state of the electrically operated valves.

The Worst washing machine has a first switch for detecting a predetermined temperature level of the hot water. The user of the washing machine can choose whether he or she wishes to use hot or just warm water for washing. If the user selects hot water, a hot water valve lets in only hot water as long as a specific, predefined temperature value is not exceeded. When, however, the temperature value is reached, the switch is closed and, as a result, operates the electrically operated valve, which additionally allows cold water to flow into the washing tub.

If, on the other hand, the user has selected warm water for another washing process, the user operates a control switch. The hot water valve, alone, is first opened in this case too. A second switch detects a temperature level that corresponds to a predetermined temperature of the warm water. If this temperature level is exceeded, a second switch is closed such that cold water additionally flows into the washing tub as well.

The Worst washing machine, therefore, permits washing at two different, predefined temperatures. However, the choice of washing program is restricted to just these two temperatures. A disadvantage of the prior art method is that it is not always expedient to first fill the washing tub with hot water and, then, add the cold water depending on the desired temperature. This is because hot water may also cause soiling on the item of laundry to solidify, which can be removed again only with difficulty. One example of this is albumen compounds, which harden due to coagulation of the albumen in the item of laundry. The coagulation takes place only above a specific temperature that is exceeded by initial filling of the washing tub with hot water.

### SUMMARY OF THE INVENTION

It is accordingly an object of the invention to provide a water-bearing household appliance, in particular, a washing machine, that overcomes the hereinafore-mentioned disadvantages of the heretofore-known devices of this general type and that can be used in a flexible manner at various temperatures.

With the foregoing and other objects in view, there is provided, in accordance with the invention, a water-bearing household appliance, including a mixing faucet, a feed line fluidically connected to the mixing faucet, a first water supply line fluidically connected to the mixing faucet for supplying cold water to the mixing faucet, a second water supply line fluidically connected to the mixing faucet for supplying hot water to the mixing faucet, a housing, a washing tub disposed in the housing and being fluidically connected to the feed line for filling the washing tub with water, and a regulating device connected to the mixing faucet and regulating a temperature of the water flowing into the washing tub, the mixing faucet being integrated in the regulating device.

According to the invention, a washing machine has a mixing faucet integrated in a regulating device by which the temperature of the water flowing into the washing tub can be regulated.

The invention makes it possible to set a predefined temperature for any desired program without the temperature being dependent on the temperature of the hot water available from the hot water line. This temperature may have very different values, for example, 40° C. or, else, 80° C., and cannot be defined beforehand. Therefore, considerable risks are associated with feeding inflow water, at an inflow temperature that is not precisely regulated, into a water-bearing household appliance; in particular, feeding inflow water into a dishwasher or into a washing machine, as described in the prior art for the treatment of the dishes to be cleaned, but, particularly, of a load of laundry to be washed.

The invention, for the first time, allows the inflow temperature of the fed-in water to be continuously adapted and changed. In all cases, only inflow water at a regulated temperature is fed in by a mixing faucet that is in communication with both a cold water line and a hot water line. As such, the hot water is utilized effectively. The mixing faucet, because it is part of a regulating device, continuously interchanges data with a regulator so that the temperature required for the respective washing or cleaning process is set exactly. The introduction of water that is at the correct temperature according to the invention shortens the entire washing process because subsequent mixing of cold and hot water is no longer necessary.

In accordance with another feature of the invention, the temperature of the water flowing into the washing tub can be predefined advantageously by a program control unit as a function of executing the program in the household appliance. A specific temperature of the water flowing in is selected for each individual program. If the program control unit can perform the regulation, scarcely any more electrical power is required in the cleaning or washing process. As a result, the most effective temperature can also be selected in an appropriate manner in conjunction with a cleaning agent added to the water both before the cleaning or washing process begins and throughout the entire process, using the available hot water. A precisely determined temperature of the inflow water can be selected even before the cleaning or washing process begins.

In accordance with a further feature of the invention, the washing tub contains an additional heater that heats the water supplied from the feed line to an even higher temperature. This heater, then, is used only when a cleaning process is to be carried out whose temperature is still above the temperature of the supplied hot water.

In accordance with an added feature of the invention, it has, furthermore, proven to be advantageous for a fuzzy logic configuration to be integrated into the program control unit. The program control unit can, then, also be matched to changing conditions within the household appliance.

With the objects of the invention in view, there is also provided a washing machine, including a mixing faucet, a feed line fluidically connected to the mixing faucet, a first water supply line fluidically connected to the mixing faucet for supplying cold water to the mixing faucet, a second water supply line fluidically connected to the mixing faucet for supplying hot water to the mixing faucet, a washing tub fluidically connected to the feed line for filling the washing tub with water, and a regulating device connected to the mixing faucet and regulating a temperature of the water flowing into the washing tub, the mixing faucet being integrated in the regulating device.

The invention provides a cleaning or washing process in which considerable amounts of electrical energy, and also time, can be saved because a longer-lasting heating process is dispensed with. It is only occasionally necessary to additionally switch on the heater in the washing tub.

Furthermore, the mixing faucet of the invention can also be used in other fields of technology, for example, in the food industry and in the chemical industry. The regulated mixing faucet can be used in conjunction with a building used for technical purposes or for energy management, for example, with the open Local Operating System (LON) technique. In such a case, the mixing faucet may be controlled centrally and carry out a large number of processes, for example, rinsing of a pipeline system to kill Legionella bacteria or other bacteria in a precise and verifiable manner. The invention permits unrestricted use of existing hot water in the washing process, whereas, in contrast to the invention, a conventional mixing faucet can only guarantee the value that has been set. In contrast, the LON technique provides the possibility of starting the washing machine only when the controller has checked whether or not the option of warm water is available in the tank.

Other features that are considered as characteristic for the invention are set forth in the appended claims.

Although the invention is illustrated and described herein as embodied in a water-bearing household appliance, in particular, a washing machine, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic partially hidden and partially cross-sectional view through a washing machine according to the invention; and

FIG. 2 is a block circuit diagram of the regulating circuit according to the invention.

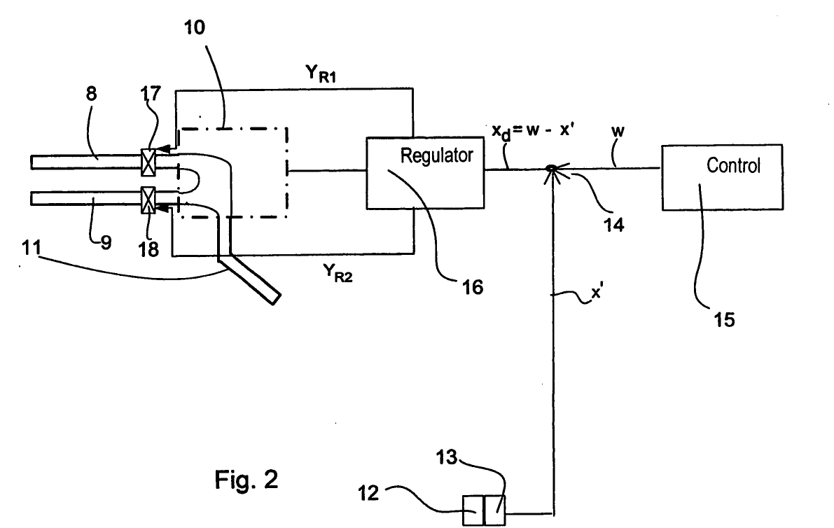

### DESCRIPTION OF THE PREFERRED EMBODIMENTS

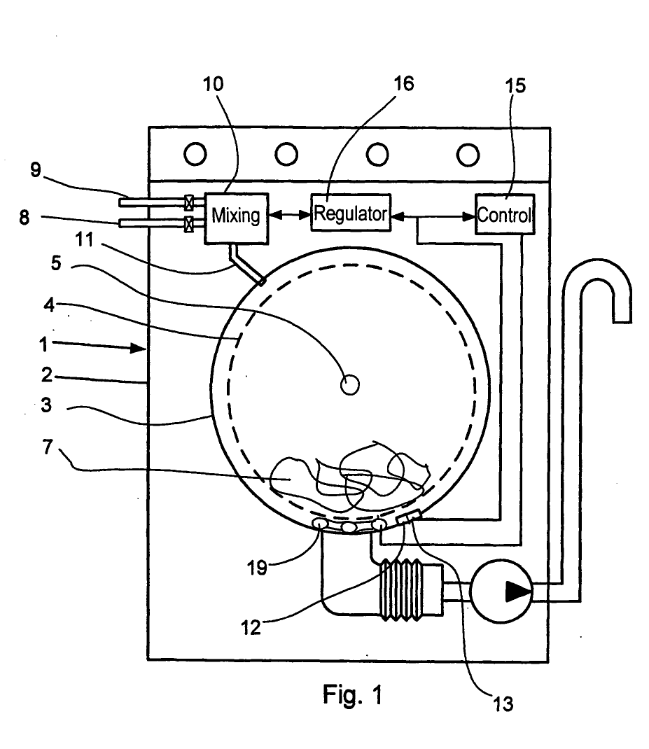

Referring now to the figures of the drawings in detail and first, particularly to FIG. 1 thereof, there is shown a washing machine 1 (FIG. 1) having, in a housing 2, a washing tub 3 in which a laundry drum 4 is mounted such that it can rotate about a shaft 5 and such that it can be driven by a non-illustrated drive unit. The laundry drum 4 is loaded with a load of laundry 7 by a non-illustrated filling opening. A mixing faucet 10 is supplied with hot water by a water supply line 8 and with cold water by a water supply line 9. The output of the mixing faucet is connected to the washing tub 3 by a feed line 11.

Temperature-controlled water is introduced into the washing tub 3 by the feed line 11 in a manner corresponding to the temperature of the washing solution measured by a temperature sensor 12 that, preferably, is fit close to the bottom of the washing tub 3.

For such a purpose, the temperature of the washing solution is obtained as a signal variable x′ in a transducer 13 associated with the temperature sensor 12. This signal variable is supplied to a subtractor 14 that calculates the difference X_{d} between the signal variable x′ and a reference variable w generated by a program control unit 15. The reference variable w is the variable whose value, that is to say, the setpoint value, can assume the desired variable in defined conditions. It is supplied to the subtractor 14 from an external source, that is to say, by the program control unit 15. A regulator 16 produces signal variables Y_{R1} and Y_{R2} from the difference value X_{d}, on the basis of which solenoid valves 17, 18 in the mixing faucet 10 are opened and closed to supply water at the desired temperature, obtained by mixing the cold water and the hot water from the two water supply lines 8, 9, to the washing tub 3 by the feed line 11. The mixing faucet 10, therefore, acts as an actuator in the control loop.

If the water flowing out of the mixing faucet 10 is still not at a sufficiently high temperature, it is raised to the required high temperature by a heater 19 serving as an additional heater and disposed in the bottom region of the washing tub 3. In such a case, the heater 19 is also connected to the program control unit 15 by a signal line.

Preferably, a fuzzy logic unit is disposed in the program control unit 15 and takes into consideration additional measurement variables of the washing solution, for example, the surface tension or the pH.

In accordance with the invention, a water-bearing household appliance, such as a washing machine, is equipped with a mixing faucet 10 that is part of a regulating device. In addition to the mixing faucet 10, the regulating device includes the regulator 16, the temperature sensor 12, the transducer 13, and the subtractor 14.

1. A water-bearing household appliance, comprising:
a mixing faucet;
a feed line fluidically connected to said mixing faucet;
a first water supply line fluidically connected to said mixing faucet for supplying cold water to said mixing faucet;
a second water supply line fluidically connected to said mixing faucet for supplying hot water to said mixing faucet;
a housing;
a washing tub disposed in said housing and being fluidically connected to said feed line for filling said washing tub with water; and
a regulating device connected to said mixing faucet and regulating a temperature of the water flowing into said washing tub, said mixing faucet being integrated in said regulating device.

2. The household appliance according to claim 1, further comprising a program control unit connected to said regulating device, said program control unit having a computing device executing a program to predefine the temperature of the water flowing into said washing tub.

3. The household appliance according to claim 1, further comprising a heater disposed in said washing tub and heating the water supplied from said feed line to a greater temperature.

4. The household appliance according to claim 2, further comprising a heater disposed in said washing tub and heating the water supplied from said feed line to a greater temperature.

5. The household appliance according to claim 1, wherein said washing tub has a heater for heating the water supplied from said feed line.

6. The household appliance according to claim 2, wherein said program control unit has an integrated fuzzy logic configuration.

7. A washing machine, comprising:
a mixing faucet;
a feed line fluidically connected to said mixing faucet;
a first water supply line fluidically connected to said mixing faucet for supplying cold water to said mixing faucet;
a second water supply line fluidically connected to said mixing faucet for supplying hot water to said mixing faucet;
a washing tub fluidically connected to said feed line for filling said washing tub with water; and
a regulating device connected to said mixing faucet and regulating a temperature of the water flowing into said washing tub, said mixing faucet being integrated in said regulating device.
